(19) United States
(12) Patent Application Publication
(10) Pub. No.: US 2023/0007877 A1
(43) Pub. Date: Jan. 12, 2023

(54) DRUM FOR REELING SHEET MATERIAL

(71) Applicant: Dyson Technology Limited, Wiltshire (GB)

(72) Inventors: Joseph Daniel HOWARD, Swindon (GB); Benjamin Jon CLEMENTS, Oldham (GB); Gregory Stanley SHEARD, Batley (GB)

(73) Assignee: Dyson Technology Limited, Wiltshire (GB)

(21) Appl. No.: 17/783,922

(22) PCT Filed: Dec. 4, 2020
(86) PCT No.: PCT/GB2020/053123

§ 371 Date: Jun. 9, 2022

(30) Foreign Application Priority Data
Dec. 11, 2019 (GB) 1918185.8

(51) Int. Cl. H01M 10/04; B65H 75/24; H01M 10/0585

(52) U.S. Cl. CPC H01M 10/0404; B65H 75/249; B65H 75/2495; H01M 10/0585; B65H 2301/414326; B65H 2301/4212; B65H 2301/42172; B65H 2301/4229; B65H 2301/515123; B65H 2301/51514; B65H 2301/5152; B65H 2301/51536; B65H 2301/42242; B65H 2701/19

(57) ABSTRACT

A drum arranged for reeling and dividing an elongate web of sheet material to produce discrete stacks of web portions is provided. The drum includes a series of faces forming a web-receiving loop that extends around a central axis of the drum, each face of the drum being defined by a respective drum segment that is configured to support a respective stack of web portions of a web reeled onto the web-receiving loop. The drum segments are movable to enable the web-receiving loop to expand to increase tension in a web reeled onto the web-receiving loop to divide the elongate web into discrete stacks.

### TECHNICAL FIELD

The invention relates to a drum for reeling a web of sheet material. In particular, the invention relates to a drum that is configured to divide, or singulate, reeled sheet material into discrete stacks, such stacks defining solid-state devices such as solid-state batteries.

### BACKGROUND

Despite promising various advantages, solid-state battery technology has historically been prohibitively expensive and notoriously resistant to economies-of-scale, which has thus far prevented its general adoption.

To illustrate the challenges involved in mass-producing SSBs, in one approach SSB cell stacks may be formed on a continuous thin film substrate to define a “web”, which is folded or wound into layers and then cut to form discrete multi-layer stacks. The web is defined by a layered structure composed of discrete layers of the requisite anode, cathode and electrolyte materials on a substrate, and so each stack defines a stack of

SSB cells. Such webs must be extremely thin, in the order of a few microns, to minimise resistivity and maximise energy density. Cost viability also dictates that the web must be of great length, for example in the order of hundreds of metres. Handling such long and thin webs is a considerable challenge, especially if the stacks are to be formed at high speed and without damage to the web.

To complicate matters further, the number of layers in an SSB stack may be an order of magnitude greater than for equivalent stacks of conventional battery cells. In consequence, tolerances governing alignment of the edges of the layers of each stack are smaller, since alignment errors accumulate as layers are added.

It is against this background that the present invention has been devised.

### SUMMARY OF THE INVENTION

According to an aspect of the present invention there is provided a drum arranged for reeling and dividing an elongate web of sheet material to produce discrete stacks of web portions. The drum comprises a series of faces forming a web-receiving loop that extends around a central axis of the drum, each face of the drum being defined by a respective drum segment that is configured to support a respective stack of web portions of a web reeled onto the web-receiving loop. The drum segments are movable to enable the web-receiving loop to expand to increase tension in a web reeled onto the web-receiving loop to divide the elongate web into discrete stacks.

The drum therefore provides a convenient means for handling a fragile, lightweight web from which solid-state devices are to be formed, although the drum is not limited to use with such webs.

Advantageously, the drum allows the initial web to be divided into stacks of web portions by breaking the web through tension, minimising the need to cut the web. This is especially beneficial if the web is a layered structure composed of a substrate carrying coating layers, which is configured to form solid-state devices, as cutting such a web tends to damage and/or crack the coating layers and thus impairs product quality.

Moreover, the drum provides for the forming of multiple discrete stacks of web portions simultaneously, since a respective stack is formed on each face of the drum. Accordingly, the drum facilitates an accelerated fabrication process and so contributes to a lowering of the cost of producing solid-state devices.

Breaking the web into stacks in a single operation also helps to ensure that the layers in each stack are accurately aligned.

In some embodiments, the drum segments are configured to move apart to expand the web-receiving loop.

At least one, and optionally all, of the drum segments may be movable radially with respect to the central axis to expand the web-receiving loop. One or more of the drum segments may be supported for outward radial movement, for example, and optionally supported to allow differential radial movement of axial ends of the face of the drum associated with the drum segment, so that expansion of the web-receiving loop comprises differential radial expansion of axial ends of the drum.

In some embodiments, at least one drum segment is rotatable around one or more axes parallel and/or orthogonal to the central axis. Also, at least one drum segment may be supported for circumferential movement relative to the central axis.

The drum segments are optionally supported for synchronised movement, for example to allow the segments to move in unison. The drum may be configured such that movement of the drum segments causes uniform expansion and contraction of the web-receiving loop with respect to the central axis. This allows the drum to increase hoop stress evenly throughout the reeled web.

The faces of the drum are optionally equidistant from the central axis of the drum when the web-receiving loop is fully contracted. Similarly, the faces of the drum may be equi-angularly spaced around the central axis when the web-receiving loop is fully contracted. So, if the drum has a sufficient number of faces the web-receiving loop may be approximately circular, which helps to reduce cyclical loads imparted to the web during reeling.

The faces of the drum may form a continuous surface when the web-receiving loop is fully contracted.

At least one, and optionally all, of the faces of the drum may be planar.

The web-receiving loop may define a polygon when fully contracted, optionally a regular polygon, each side of the polygon corresponding to a respective face of the drum.

The faces of the drum may be substantially identical. Also, the drum segments may be substantially identical.

Each drum segment may comprise one or more drum elements such as plates and/or wedges. Drum segments or elements may be linked to support each other. Alternatively, or in addition, the drum may include a support structure such as a frame that supports the drum segments and optionally any elements of the drum segments.

The drum optionally comprises a drive mechanism to effect movement of the drum segments to expand and contract the web-receiving loop.

Each face of the drum may extend parallel to the central axis.

The invention also extends to a drum assembly comprising the drum of the above aspect rotatably mounted on a drum support. A further aspect of the invention provides a web processing system comprising such a drum assembly. The web processing system may also comprise a feed system configured to feed a web onto the drum.

The web processing system may also comprise discontinuity-forming equipment arranged to form discontinuities in the web at spaced intervals corresponding to edges of the faces of the drum. The discontinuities may comprise perforations and/or thinned regions of the web, in which case the discontinuity-forming equipment is optionally configured to perforate and/or ablate the web to form discontinuities. The discontinuity-forming equipment may comprise a laser and/or a cutting member such as a blade, for example.

The discontinuities act to weaken the web locally and therefore control the points at which the web breaks when placed under tension by expansion of the drum. Accordingly, creating discontinuities enables the shape of the final stacks to be controlled.

The web processing system may comprise clamps to hold each stack on its respective drum segment.

Another aspect of the invention provides a method of producing discrete stacks of web portions from an elongate web of sheet material. The method comprises reeling the web onto a drum, and expanding the drum to increase tension in the web and thereby divide the elongate web into discrete stacks.

The drum may comprise a series of faces forming a web-receiving loop that extends around a central axis of the drum, each face of the drum being defined by a respective drum segment that is configured to support a respective stack of web portions of a web reeled onto the web-receiving loop. In this case, reeling the web onto the drum comprises reeling the web onto the drum segments around the web-receiving loop, and expanding the drum to divide the elongate web into discrete stacks comprises driving relative movement of the drum segments to expand the web-receiving loop. Such methods may comprise moving at least one, and optionally all, of the drum segments radially to expand the web-receiving loop. This may involve effecting different radial movement of axial ends of at least one drum segment, and optionally moving the drum segments to effect differential radial expansion of axial ends of the drum. Movement of the drum segments may be synchronised, and the same movement may be applied to each drum segment.

The method may further comprise: forming transverse discontinuities in the web at spaced intervals corresponding to edges of the stacks to be formed, so that the intervals progressively increase along the web; and breaking the web at each discontinuity to divide the web into stacks.

In some embodiments, the method comprises clamping the web onto the drum before expanding the drum.

The method may comprise applying a two-stage movement to at least one drum segment. For example, the two-stage movement may comprise a tilting phase, in which differential radial expansion is applied to front and rear ends of the drum, and a radial translation phase, in which the front and rear ends of the drum expand at the same rate.

The invention also embraces a control system arranged to control a web processing system to perform the method of the above aspect to produce discrete stacks of web portions from an elongate web of sheet material.

In any of the aspects of the invention set out above, the elongate web may comprise a substrate layer and one or more coating layers, in which case the discrete stacks may define solid-state electrical devices.

It will be appreciated that preferred and/or optional features of each aspect of the invention may be incorporated alone or in appropriate combination in the other aspects of the invention also.

### BRIEF DESCRIPTION OF THE DRAWINGS

One or more embodiments of the invention will now be described, by way of example only, with reference to the accompanying drawings, in which:

FIG. 1 shows in schematic form a web suitable for producing solid-state devices in embodiments of the invention;

FIG. 2 shows an initial processing step for the web of FIG. 1;

FIG. 3 is a perspective view of an expandable drum configured to reel and divide the web of FIG. 1 into discrete stacks;

FIG. 4 shows the drum of FIG. 3 from the front to reveal internal features of the drum;

FIGS. 5a and 5b show, in front and perspective views respectively, the drum in an initial stage of radial expansion;

FIGS. 6a and 6b correspond to FIGS. 5a and 5b but show the drum in a fully expanded state;

FIGS. 7a, 8a and 9a show the drum from the front during three stages of an umbrella movement mode, while FIGS. 7b, 8b and 9b correspond, respectively, to FIGS. 7a, 8a and 9a, but show the drum in perspective view;

FIG. 10 shows a web processing system incorporating the drum of FIG. 3;

FIG. 11 is a detail view of a plate of the drum of FIG. 3 following expansion; and

FIG. 12 shows a portion of web that has been processed by the web processing system of FIG. 10.

### DETAILED DESCRIPTION

To meet the challenges involved in mass producing solid state devices such as batteries, embodiments of the invention form such devices by folding and dividing elongate webs of sheet material into discrete stacks. As already noted, such webs may be only a few microns in thickness whilst being hundreds of meters in length, making them difficult to handle.

For example, as it is so thin the web is extremely lightweight and fragile, giving rise to the conflicting challenges of holding the web under tension to preserve its shape and control its position, while limiting that tension to avoid rupturing the web.

As also noted above, it is desirable to maximise the number of layers in each stack to yield a corresponding increase in energy density, which entails many folds in the web and the associated increased difficulty in ensuring that the edges of the layers of the stack remain aligned. Folding the web also creates a high bend radius at each fold, which generates stress in the web coatings.

For this reason, conventional S-folding techniques used for fabricating other electrical devices have been found unsuitable for forming solid-state devices in this way.

Accordingly, embodiments of the invention provide an approach to folding and dividing the web that minimises fluctuations in the tension applied to the web, reduces the bend radius applied to the web and also ensures accurate edge alignment. In broad terms, this approach involves reeling the web onto a drum, creating transverse discontinuities in the web such as perforations and/or ablated regions such that the discontinuities form angularly spaced, radially-aligned groups on the drum, and then expanding the drum to increase hoop stress to break the reeled web along each discontinuity to produce the discrete stacks that will define solid-state devices.

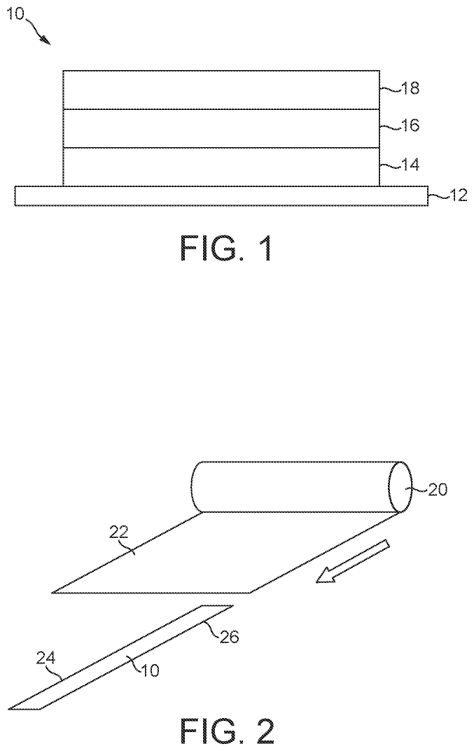

In that context, FIG. 1 shows in schematic form the structure of a web 10 that may be used in embodiments of the invention. The web 10 is defined by a layered structure, which in this case is composed of four discrete layers, each layer extending uniformly through the web in two dimensions.

In upward vertical succession as viewed in FIG. 1, the web comprises: a substrate 12; an anode layer 14; an electrolyte layer 16; and a cathode layer 18. It should be appreciated that FIG. 1 is entirely schematic, and so the relative thicknesses of the layers may be different in practice.

The substrate 12 is of a suitable thin plastics web material such as PET (polyethylene terephthalate), and is of one micron or less in thickness in this embodiment; although in other embodiments the substrate 12 could be thicker, for example up to 10 microns.

The anode, electrolyte and cathode layers are formed onto the substrate 12 as coatings using well-known techniques.

In this embodiment, the anode layer 14 is formed from lithium metal, although lithium alloy may alternatively be used. The electrolyte layer 16 is of lithium phosphorous oxynitride, but other suitable fast ion conductors are known. It follows from this that the material selected for the cathode layer 18 is suitable for storing lithium ions by virtue of stable chemical reactions. Suitable materials for the cathode layer 18 therefore include lithium cobalt oxide, lithium iron phosphate or alkali metal polysulphide salts, although any alkali metal oxide supplemented with aluminium, manganese and/or cobalt may be used.

The skilled person will be aware of other materials suitable for forming solid-state device cells, and any compatible combination of such materials may be implemented in embodiments of the invention.

The skilled reader will appreciate that the structure shown in FIG. 1 provides all of the requisite layers to define a cell of a solid-state battery device. The web 10 could therefore be characterised as a single solid-state cell, albeit one that is too large to serve a practical purpose. Accordingly, the web 10 is broken or otherwise divided into smaller web portions, each web portion defining a solid-state cell of a useful size. These cells are stacked to form solid-state devices of high energy density, most conveniently by folding or otherwise layering the web 10 before dividing it, and in this case by reeling it onto a drum as described below.

The web 10 shown in FIG. 1 represents one of the simplest structures that may be used, but in other embodiments further layers may be included so that the substrate 12 supports multiple cells. This beneficially minimises the parasitic mass represented by the substrate 12, in turn improving the energy density of solid-state devices produced from the web 10.

For example, the cathode, electrolyte and anode layers 14, 16, 18 may be repeated, so that the substrate 12 supports the requisite layers for two cells of a solid-state device, with one cell stacked on top of the other.

The additional set of anode, electrolyte and cathode layers may be added on top of those present in the example shown in FIG. 1 to repeat the layering pattern, in which case a barrier layer may be provided between the respective sets of cathode, electrolyte and anode layers to separate the respective cells.

Another option is to add an electrolyte layer followed by an anode layer onto the FIG. 1 structure, meaning that the cathode layer 18 effectively forms part of two cells. In this scenario, the cathode layer may be thicker than for the single cell arrangement of FIG. 1.

Alternatively, or in addition, further coating layers may be added to the underside of the substrate 12, so that the substrate 12 becomes sandwiched between two sets of anode, electrolyte and cathode layers.

In principle, it is possible for the web 10 to have any number of layers in any of the configurations noted above for the purposes of the invention.

To ease manufacture, transport and handling, the web 10 to be reeled onto the drum is typically cut from a reel of sheet material having a width that is much greater than the intended width of the solid-state devices to be produced. Accordingly, an initial step in the process for producing discrete stacks of web portions defining multi-celled solid-state devices is to cut the sheet material into ribbon-like webs 10 having a width corresponding to the desired width of the solid-state devices to be produced. Each web 10 can then be wound onto the drum individually to be divided into the final stacks that will define the solid-state devices.

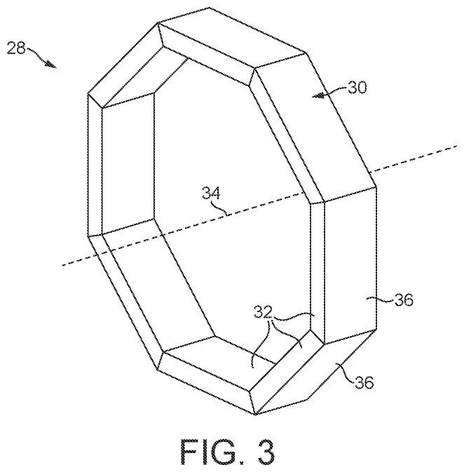

This step is illustrated in FIG. 2, which shows a reel 20 of sheet material 22 being unwound in the direction indicated by the arrow, and cut longitudinally to produce a web 10 that is approximately one sixth of the width of the reel. Accordingly, six such webs are produced from the sheet material 22, although only one is shown in FIG. 2 for simplicity. As FIG. 2 indicates, the web 10 is also cut to length ready for reeling onto the drum.

Once cut, films or foils of appropriate materials are deposited along the long sides of the web 10 to define current collectors for the anode and cathode layers 14, 18, an anode current collector 24 being formed along one side of the web 10 and a cathode current collector 26 being formed along the opposite side. The anode current collector 24 may be formed from zinc, aluminium, platinum or nickel, for example. The cathode current collector 26 is of nickel in this embodiment, but platinum or aluminium may alternatively be used.

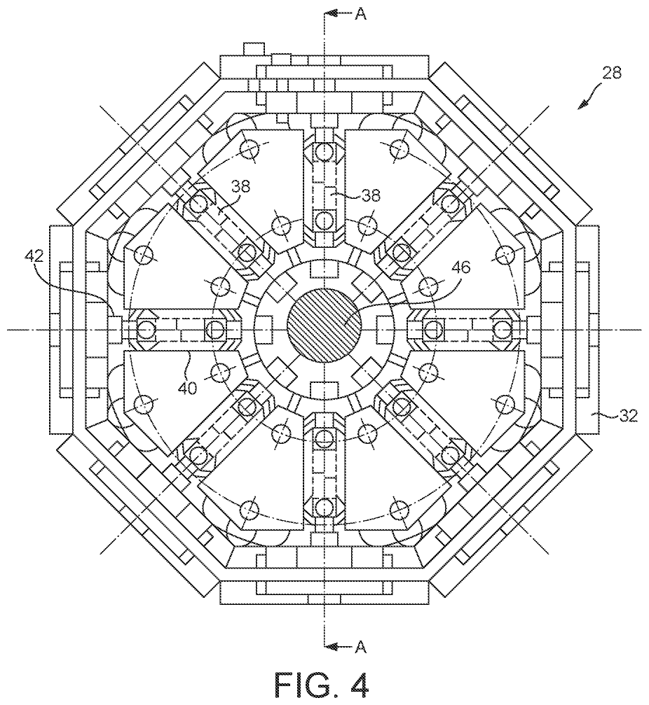

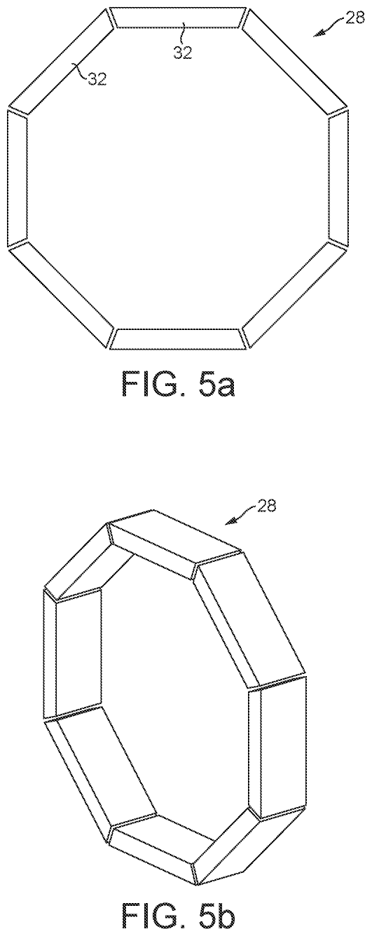

FIG. 3 shows in perspective view an embodiment of a drum 28 for reeling and dividing a web 10 prepared as outlined above to produce discrete stacks of web portions. The drum 28 is greatly simplified in FIG. 3 to show only elements forming a web-receiving loop 30 onto which a web 10 may be wound. FIG. 4 shows more of the internal structure of the drum 28.

In the embodiment shown in FIG. 3, the drum 28 comprises eight identical drum elements in the form of flat plates 32 arranged in a loop around a central axis 34, such that the loop assumes the form of a regular, eight-sided polygon. Each plate 32 has a planar, oblong web-receiving surface 36 that faces radially outwardly to define a respective face of the drum 28.

Each plate 32 is an isosceles trapezium in radial cross-section, the longer base of the trapezium corresponding to the web-receiving surface 36. This shape allows the plates 32 to engage one another such that their respective web-receiving surfaces 36 adjoin to form a substantially continuous surface that defines the web-receiving loop 30.

Accordingly, the surface defining the web-receiving loop 30 extends continuously circumferentially, and extends parallel to the central axis 34 between a front and a rear of the drum 28 with respect to the orientation depicted in FIG. 3. The lengths of the plates 32 therefore define the axial extent of the web-receiving loop 30, which is sized to correspond to the width of webs to be reeled onto the drum 28. In turn, the width of a web 10 corresponds to the length of solid-state devices to be formed from the web 10 using the drum 28.

The plates 32 are supported for relative movement such that the drum 28 is expandable from a closed state, in which the web-receiving surfaces 36 of the plates 32 adjoin, to move the plates 32 apart and thereby increase the length of the web-receiving loop 30, in turn raising tension in a web 10 that has been wound onto the drum 28 to break the web 10 into discrete stacks. Accordingly, the drum 28 may be considered segmented in that each plate 32 defines a respective drum segment. In other embodiments, drum segments may be formed from multiple elements such as plates or wedges.

The skilled reader will appreciate that there are various ways in which the plates 32 may move relative to one another to increase the length of the web-receiving loop 30 and thereby apply increasing tension to a reeled web 10. In this embodiment, the plates 32 are arranged to move radially outwardly in unison to expand the web-receiving loop 30, and then to move radially inwardly to return the drum 28 to its original state.

In this respect, FIG. 4 shows the drum 28 from the front, revealing a circular array of independently-operable double-acting actuators 38 that each supports a respective plate 32 of the drum 28 at an end of the plate 32 at the front of the drum 28. Each actuator 38 comprises a radially-inward body 40 and a radially outward arm 42 arranged telescopically within the body 40, such that the arm 42 is moveable linearly into and out of the body 40 to extend and contract the actuator.

The actuators 38 are collectively supported by a frame of the drum 28, which secures the body 40 of each actuator 38 in a fixed position relative to the frame. The arm 42 of each actuator 38 is coupled to a respective plate 32, so that extension of the actuator 38 by outward movement of the arm 42 drives corresponding radial movement of the plate 32 with respect to the frame.

A central axle 46 is journalled within the frame, so that the drum 28 is rotatable when the axle 46 is mounted on a drum support.

It should be appreciated that a corresponding set of actuators sits directly behind those visible in FIG. 4 to support the corresponding ends of the plates 32 at the rear of the drum 28. Accordingly, the drum 28 comprises a front set of actuators and a rear set of actuators, and each plate 32 is supported by a respective pair of actuators, one from each set.

Each actuator arm 42 connects to its respective plate 32 through a suitable linkage that allows the plate 32 to pivot about an axis parallel to the edge of the web-receiving surface 36 of the plate 32 coinciding with the front of the drum 28. The linkage also allows for axial movement of the plate 32 relative to the actuator 38 to some extent. In this way, the front and rear actuators 38 may extend by different amounts to impart both radial and rotational movement to the associated plate 32, thereby tilting the plate 32 relative to the central axis 34. Notably, this allows for differential radial expansion of the front and rear of the drum 28 through suitable control of the front and rear sets of actuators 38.

As an alternative means of accommodating tilting of the plate 32 relative to the central axis 34 as a result of differential radial extension of the actuators 38 at each end of the plate 32, one or both of the actuators 38 attached to a plate 32 may be pivotable relative to the frame.

This arrangement gives rise to various movement modes for the drum 28 by operating the actuators 38 in different ways. Different movement modes may offer benefits in use for dividing webs reeled onto the drum 28, as shall be explained later. First, some specific movement modes are considered in more detail.

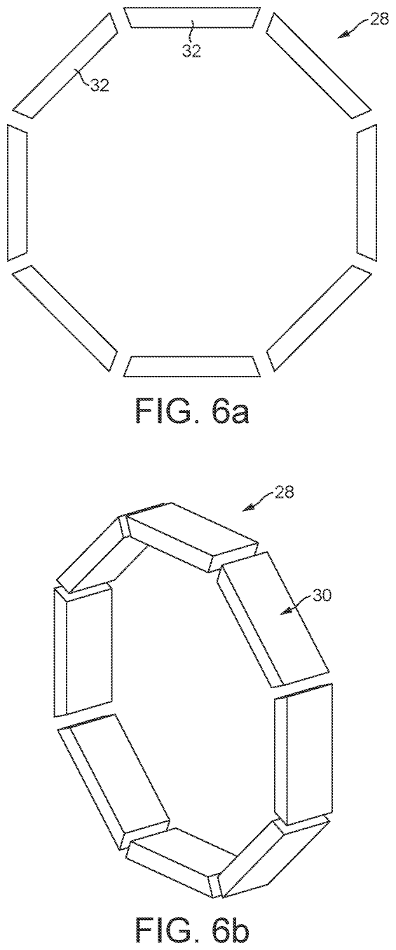

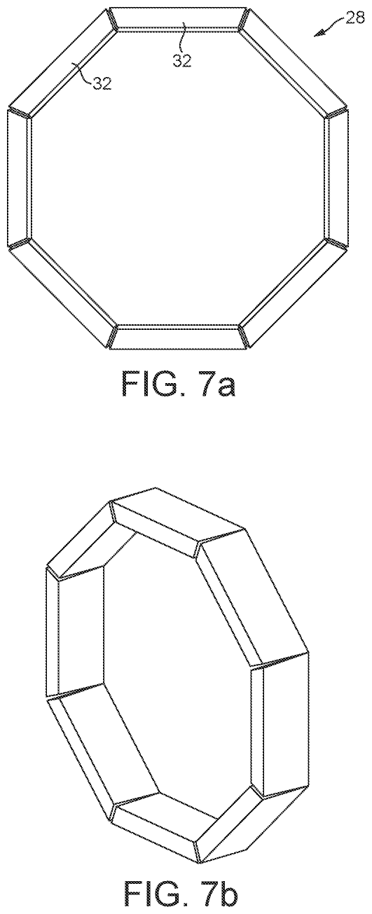

The simplest movement mode is illustrated in FIGS. 5a to 6b, in which the actuators 38 are operated in unison to extend at the same rate so that the front and rear of the drum 28 expand radially in equal measure. This is referred to as a ‘true radial’ motion. FIGS. 5a and 5b show the drum 28 in front and perspective views respectively as the plates 32 begin to move apart, so that small gaps are visible between each pair of neighbouring plates 32. This movement continues until the drum 28 reaches the state shown in FIGS. 6a and 6b, in which the gaps between the plates 32 have grown such that the overall length of the web-receiving loop 30 defined by the plates 32 has increased significantly compared to the original state of FIG. 3. For example, for a drum 28 having a diameter of between 0.5 and 2 metres, each plate 32 may undergo radial movement of around 5-10 mm to expand the web-receiving loop 30, although these dimensions and distances will vary according to the requirements of each application.

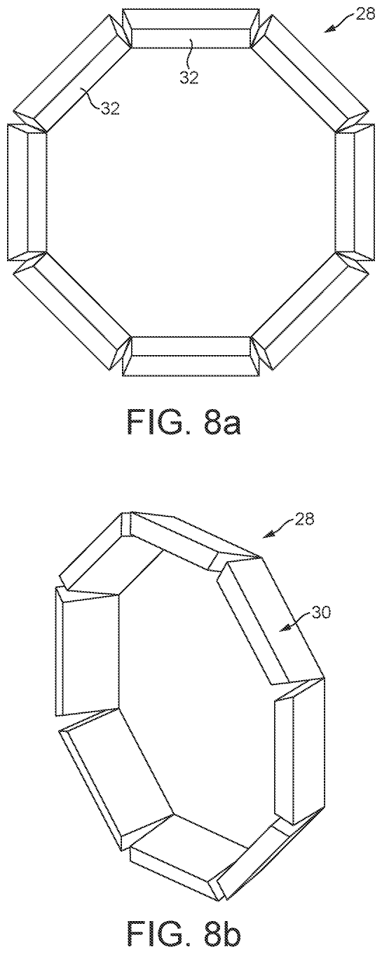

By virtue of the independently operable actuators 38, the plates 32 are also supported such that the axial ends of each plate 32 can move to a differing extent, as already noted. So, the front and the rear of the drum 28 may undergo differential radial expansion, which is referred to as an ‘umbrella’ motion and is illustrated in FIGS. 7a to 9b.

FIGS. 7a and 7b show, in front and perspective views respectively, gaps starting to form between the plates 32 at the front of the drum 28 only, as the plates 32 begin to tilt. As seen most clearly in FIG. 7b, at this stage the plates 32 remain in contact with one another at the rear of the drum 28. This state results from initiating expansion of the front set of actuators 38 while holding the rear set of actuators 38 in a retracted state, causing each plate 32 to tilt relative to the central axis 34 so that the plates 32 collectively splay outwardly at the front of the drum 28.

FIGS. 8a and 8b correspond to FIGS. 7a and 7b but show a later stage of the process, at which the front of the drum 28 has expanded to a greater extent. At this stage, the second set of actuators 38 are activated so that the rear of the drum 28 begins to expand also. The front and rear sets of actuators 38 are then controlled so that all actuators 38 expand at a uniform rate to maintain a constant tilt in each plate 32, until the drum 28 reaches a fully expanded state as shown in FIGS. 9a and 9b.

The umbrella motion shown in FIGS. 7a to 9b may be considered a two-stage movement to the extent that it involves an initial tilting stage followed by an expansion stage during which the plates translate radially. Other two-stage movements are possible, for example by reversing the order of operations shown in FIGS. 7a to 9b to expand the drum 28 to an intermediate position in a first stage of movement, before expanding the front of the drum 28 to tilt the plates 32 into the fully expanded state of FIG. 9b in a second state of movement. It is also possible for the tilting and expansion movements to occur simultaneously, for example by operating all actuators 38 at once but expanding the front set of actuators 38 at a higher rate than the rear set of actuators 38.

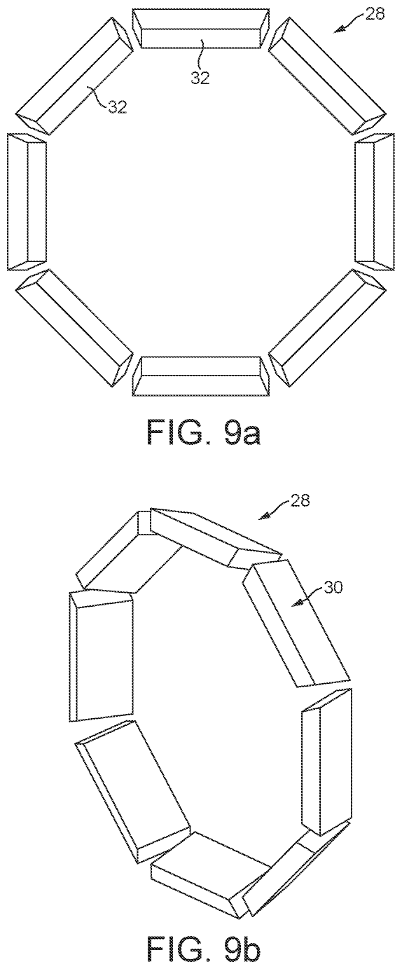

With the operation of the drum 28 described, referring now to FIG. 10 the drum 28 is shown in its context of use as part of a web processing system 50. The web processing system 50 is configured to rotate the drum 28 while feeding a web 10 onto the web-receiving loop 30, to build up layers of the web 10 on the drum 28 until a target number of layers is reached, and to divide the reeled web 10 into discrete stacks by expanding the drum 28.

The drum axle 46 is mounted between a pair of pillars 52 defining a drum support, one of which pillars is visible in FIG. 10, so that the drum 28 is suspended between the pillars and can rotate in the direction indicated by the arrow. Rotation of the drum 28 is effected by a drive mechanism such as an electric motor (not shown) in the conventional manner The motor may be integrated into the drum 28, or may be separate from the drum 28 and part of the wider system.

As the drum 28 rotates, it draws a web 10 around its web-receiving loop 30, building up layers of the web 10 until a sufficient number is reached, at which point the drum 28 is expanded using one of the movement modes described above to apply tension to the web 10 and divide the web 10 into discrete stacks. The web 10 is fed onto the web-receiving loop 30 of the drum 28 by a feed system (not shown) that may either be part of the web processing system 50 or a separate system.

It is noted that the approximately circular shape of the web-receiving loop 30 acts to minimise peaks in the tension within the web 10 during reeling, as well as minimising the bend radius imposed on the web 10 at each interface between adjacent plates 32. Although the web tension, or hoop stress, will rise each time the web 10 is engaged by one of the ‘corners’ of the drum 28, namely the interfaces between the plates 32, as the angle between the plates 32 is shallow the increase in tension is minimal. This in turn minimises the risk of stretching and potentially rupturing the web 10 during reeling.

It will be appreciated that increasing the number of faces on the drum 28 will have the effect of smoothing tension applied to the web 10 during reeling, and so in practice the drum 28 may have more than eight faces.

The web processing system 50 also includes discontinuity-forming apparatus in the form of a laser ablation machine 54, which is configured to form discontinuities into the web 10 at predefined angular positions corresponding to interfaces between neighbouring plates 32 of the drum 28. This may be achieved by controlling operation of the laser ablation machine 54 in response to an output from an encoder associated with a motor (not shown) that turns the drum 28 on its central axle 46, for example, such that the laser ablation machine 54 forms a new discontinuity each time an interface between neighbouring plates 32 aligns with a predetermined angular position.

Discontinuities may be formed as the drum 28 rotates, or alternatively the drum 28 may be stopped at each of the predefined angular positions while a discontinuity is formed.

The discontinuities formed by the laser ablation machine 54 include thinned regions extending transversely across the web 10, in which the coating layers of the web 10, namely the anode, electrolyte and cathode layers 14, 16, 18, are removed by ablation to expose the substrate 12; and transverse series of perforations that puncture through all layers of the web 10. In general terms, the perforations and thinned regions may be considered discontinuities to the extent that they break the uniformity of the coatings. In this embodiment, the discontinuities are formed during reeling, but in other embodiments the discontinuities may be formed before or after reeling.

For cases where the web comprises a substrate 12 carrying coatings on both sides, the coatings may be removed by the laser ablation machine 54 in one operation by tuning the machine to operate through the transparent substrate 12, using known principles.

In this embodiment, the laser ablation machine 54 is configured to perform the dual operations of ablating the web 10 to remove the coating layers 14, 16, 18 to expose the substrate 12, and also to penetrate the substrate to form a series of perforations that extends transversely across the web 10 through the centre of each ablated region. However, in different embodiments these operations may be performed by two separate devices, which may be positioned at respective angular positions.

It is also possible to position the laser ablation machine 54 upstream of the drum 28, to form discontinuities into portions of the web 10 that are yet to reach the drum 28.

Accordingly, the laser ablation machine 54 enables the web processing system 50 to prepare the web 10 for dividing into discrete stacks when the drum 28 is expanded, by perforating or otherwise weakening the web 10 transversely at spaced intervals. The intervals are determined such that, once the web 10 is reeled onto the drum 28, the perforations in each layer of the web 10 align with one another to form angularly-aligned groups that coincide with each interface between adjacent faces of the drum 28.

In this way, when tension in the web 10 rises as the drum 28 expands, the weakening effect of the perforations ensures that the web 10 breaks along each set of perforations, which therefore act to control the points at which the web 10 divides when the drum 28 expands.

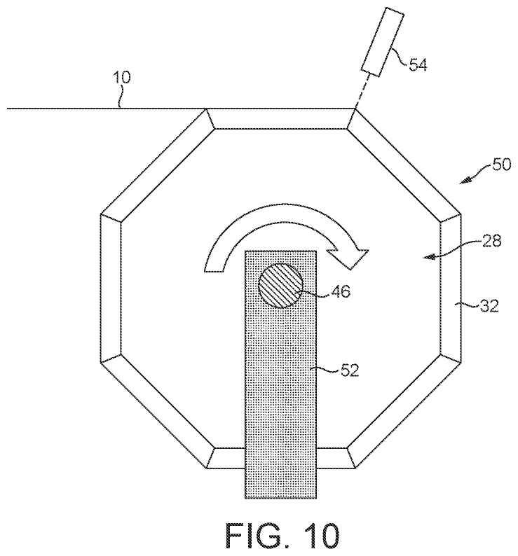

Breaking the web 10 along each set of perforations results in a respective discrete stack of web portions on each plate 32. This is illustrated in FIG. 11, which shows one of the plates 32 of the drum 28 in close-up after the drum 28 has been expanded, and illustrates a stack 56 of web portions supported on the web-receiving surface 36 of the plate 32. As the perforations are formed in angular alignment with the interfaces between each pair of plates 32, the shape of the stack 56 effectively continues the trapezoidal shape of the plate 32.

A clamp 58 holds the web 10 in place during and after expansion of the drum 28. It should be appreciated that corresponding clamped stacks 56 of web portions are present on each of the other plates 32 of the drum 28, but these are omitted from FIG. 11 for simplicity.

It follows that each face of the drum 28 acts as a support for a respective stack 56 of web portions, and the width of the stacks 56 formed corresponds to the width of the web-receiving surfaces 36 of the plates 32. Accordingly, the shape of the stacks 56 produced by the drum 28 corresponds to the shape of the faces of the drum 28.

As the layers of the web 10 accumulate on the drum 28 during reeling, the overall width of the reel of web 10 on the drum 28 increases. This in turn means that the spacing between the sets of perforations progressively increases, since the perforations are formed at predefined angular positions. This is accounted for automatically in the arrangement shown in FIG. 10, since the laser ablation machine 54 forms each new set of discontinuities when the drum 28 is at one of a predefined set of angular positions. The same principle may be applied when the laser ablation machine 54 is positioned upstream of the drum 28. Alternatively, in this case the spacing between each set of discontinuities may be calculated.

The increasing spacing between the sets of perforations implies a corresponding progressive increase in the widths of the anode, electrolyte and cathode layers 14, 16, 18 between each set of perforations during reeling. While this would have a negligible impact on the performance of the final solid-state device, the additional coating material in the higher layers of the reeled web 10 would represent a parasitic mass, and so on balance has a detrimental impact.

For this reason, the laser ablation machine 54 creates the thinned regions around each set of perforations noted above. The widths of the thinned regions progressively increase in line with the spacing between the perforations, to maintain a constant width of the anode, electrolyte and cathode layers 14, 16, 18 between each set of perforations. It follows that, after dividing the web 10 by expanding the drum 28, each discrete stack 56 has a trapezium shape that is composed of a cuboidal stack of complete layers including the coatings, flanked on each side by triangular wedges of substrate material. In this way, the ablation process helps to ensure that the edges of the anode, electrolyte and cathode layers 14, 16, 18 within each stack 56 are aligned.

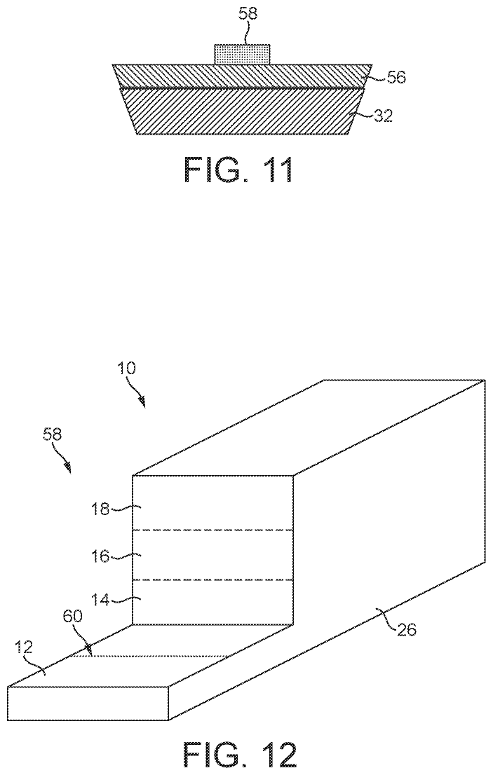

FIG. 12 shows in schematic form a portion of a web 10 into which discontinuities have been formed, and which is thus ready for breaking by expansion of the drum 28. Specifically, the portion of the web 10 shown includes a thinned region 58 in which the anode, electrolyte and cathode layers 14, 16, 18 have been removed so that only the substrate 12 remains. Ends of the coating layers 14, 16, 18 are visible where they face onto the exposed substrate 12, but the coating layers 14, 16, 18 are not visible along the side of the web 10 as they are covered by a film or foil defining a current collector, as mentioned above, with the cathode current collector 26 being visible in FIG. 12.

The exposed portion of the substrate 12 further includes a row of perforations 60 extending transversely through the centre of the thinned region 58. The perforations 60 are represented here as a regular series of small, circular openings. However, in other embodiments the pattern used for the perforations 60 may vary to optimise the manner in which the substrate 12 breaks when tension is applied. For example, the perforations 60 may be irregularly spaced. Also, different shapes may be used that are configured to generate stress concentrations at the transversely-facing edges of the perforations 60 to lower the tension required to break the substrate 12. In this respect, polygonal perforations 60 may be effective, for example diamond-shaped, parallelogram-shaped or hexagonal perforations 60.

The umbrella mode may be particularly effective for breaking the web cleanly along each set of perforations 60, due to the progressive manner in which this movement mode causes tension to be applied to the web from the front to the back of the drum 28, causing a gradual tear along each series of perforations 60. Use of the umbrella mode may be complemented by perforations 60 that are shaped to create stress concentrations at front edges, such as the polygonal perforations 60 mentioned above.

Equally, the radial mode may also be effective in creating clean breaks at the perforations 60, since it results in even application of pressure throughout the web 10. Again, a complementary perforation shape may be selected where true radial motion is to be used, for example a shape having symmetry about a longitudinal axis such as a diamond shape.

It will be appreciated that various changes and modifications can be made to the present invention without departing from the scope of the present application.

For example, other movement modes for the drum may also be possible and helpful in different embodiments. For example, the plates may be supported for translational movement along axes parallel to the central axis 34, and/or to rotate around such axes.

Some embodiments may employ movement modes in which only a subset of the plates move. For example, alternative plates may move radially to expand the drum. It is noted, however, that movements of this kind will create shear stress in the reeled web, which may have a negative impact on the division of the web.

Although the drum of the embodiment described above comprises a frame to support the drum segments relative to one another, in an alternative the segments could be interlinked to support each other.

As an alternative, or supplement to laser cutting and/or ablating using a laser ablation machine 54 as described above, mechanical cutting means such as a blade and anvil may be used to perforate and/or thin the web ready for dividing.

1. A drum arranged for reeling and dividing an elongate web of sheet material to produce discrete stacks of web portions, the drum comprising:
a series of faces forming a web-receiving loop that extends around a central axis of the drum, each face of the drum being defined by a respective drum segment that is configured to support a respective stack of web portions of a web reeled onto the web-receiving loop,
wherein the drum segments are movable to enable the web-receiving loop to expand to increase tension in a web reeled onto the web-receiving loop to divide the elongate web into discrete stacks.

2. The drum of claim 1, wherein the drum segments are configured to move apart to expand the web-receiving loop.

3. The drum of claim 1, wherein at least one of the drum segments is movable radially with respect to the central axis to expand the web-receiving loop.

4. The drum of claim 3, wherein at least one drum segment is supported to allow differential radial movement of axial ends of the face of the drum associated with the drum segment, so that expansion of the web-receiving loop comprises differential radial expansion of axial ends of the drum.

5. The drum of claim 1, wherein at least one drum segment is rotatable around one or more axes parallel and/or orthogonal to the central axis.

6. The drum of claim 1, wherein at least one drum segment is supported for circumferential movement relative to the central axis.

7. The drum of claim 1, wherein the faces of the drum form a continuous surface when the web-receiving loop is fully contracted.

8. The drum of claim 1, wherein each drum segment comprises one or more plates and/or wedges.

9. The drum of claim 1, further comprising a drive mechanism to effect movement of the drum segments to expand and contract the web-receiving loop.

10. The drum of claim 1, wherein each face of the drum extends parallel to the central axis.

11. A drum assembly comprising the drum of claim 1 rotatably mounted on a drum support.

12. A web processing system comprising the drum assembly of claim 11.

13. The web processing system of claim 12, comprising a feed system configured to feed an elongate web onto the drum.

14. The web processing system of claim 12, comprising discontinuity-forming equipment arranged to form discontinuities in the elongate web at spaced intervals corresponding to edges of the faces of the drum.

15. The web processing system of claim 14, wherein the discontinuity-forming equipment is configured to perforate and/or ablate the elongate web to form discontinuities.

16. The web processing system of claim 14, wherein the discontinuity-forming equipment comprises a laser and/or a cutting member.

17. A method of producing discrete stacks of web portions from an elongate web of sheet material, the method comprising:
reeling the elongate web onto a drum; and
expanding the drum to increase tension in the elongate web and thereby divide the elongate web into discrete stacks.

18. The method of claim 17, wherein:
the drum comprises a series of face forming a web-receiving loop that extends around a central axis of the drum, each face of the drum being defined by a respective drum segment that is configured to support a respective stack of web portions of a web reeled onto the web-receiving loop;
reeling the web onto the drum comprises reeling the web onto the drum segments around the web-receiving loop; and
expanding the drum to divide the elongate web into discrete stacks comprises driving relative movement of the drum segments to expand the web-receiving loop.

19. The method of claim 18, further comprising moving at least one of the drum segments radially to expand the web-receiving loop.

20. The method of claim 19, further comprising effecting different radial movement of axial ends of at least one drum segment.

21. The method of claim 20, further comprising moving the drum segments to effect differential radial expansion of axial ends of the drum.

22. The method of claim 18, further comprising synchronising movement of the drum segments.

23. The method of claim 18, further comprising applying the same movement to each drum segment.

24. The method of claim 17, further comprising:
forming transverse discontinuities in the elongate web at spaced intervals corresponding to edges of the discrete stacks to be formed, so that the intervals progressively increase along the web; and
breaking the elongate web at each discontinuity to divide the web into discrete stacks.

25. The method of claim 17, further comprising clamping the elongate web onto the drum before expanding the drum.

26. The method of claim 17, further comprising applying a two-stage movement to at least one drum segment.

27. The method of claim 26, wherein the two-stage movement comprises a tilting phase and a radial translation phase.

28. A control system arranged to control a web processing system to perform the method of claim 17 to produce discrete stacks of web portions from an elongate web of sheet material.

29. The drum of claim 1, wherein the elongate web comprises a substrate layer and one or more coating layers, and wherein the stacks define solid-state electrical devices.
